(19) United States
(12) Patent Application Publication
(10) Pub. No.: US 2011/0089834 A1
(43) Pub. Date: Apr. 21, 2011

(54) Z-PINCH PLASMA GENERATOR AND PLASMA TARGET

(75) Inventor: Malcolm W. McGeoch, Little Compton, RI (US)

(73) Assignee: PLEX LLC, Fall River, MA (US)

(21) Appl. No.: 12/854,375

(22) Filed: Aug. 11, 2010

Related U.S. Application Data
(60) Provisional application No. 61/253,239, filed on Oct. 20, 2009.

(51) Int. Cl. H05H 1/24

(52) U.S. Cl. 315/111.41

(57) ABSTRACT

A configuration of two opposed electrodes with conical depressions and symmetry around an axis along which there is an applied steady magnetic field, is supplied with a pulsed voltage and current to create an azimuthally very uniform pre-ionization cylinder of a working gas as a precursor to stable and accurate compression of the working gas into a Z-pinch plasma photon source or plasma target for laser-pumped photon sources. A further compound hollow electrode configuration permits the generation of a cool, dense, core plasma surrounded and compressed by a hot liner plasma. Modulation of the radial density profile within this core can provide optical guiding for a laser-pumped recombination laser.

### RELATED APPLICATIONS

This Application claims priority under 35 U.S.C. §119(e) to U.S. Provisional Application Ser. No. 61/253,239, entitled “GAS EMBEDDED Z-PINCH PLASMA GENERATOR AND PLASMA TARGET” filed on Oct. 20, 2009, which is incorporated herein by reference in its entirety.

### BACKGROUND OF INVENTION

The Z-pinch, in which a cylindrical plasma column is compressed to high temperature by the self-magnetic field of a current passing axially along it, is of utility in the generation of ultraviolet, extreme ultraviolet or soft X-ray radiation. The history of the development of the Z-pinch is reviewed in an article entitled “The past, present and future of Z pinches” by M. G. Haines et al., Physics of Plasmas 7, pp 1672-1680 (2000). In contrast to the very high energy (MJ) pinch devices that are of relevance to nuclear fusion energy, the generation of 13.5 nm extreme ultraviolet (EUV) radiation for semiconductor lithography demands a high repetition rate source, ideally 10 kHz or more, at small individual pulse energy (1 to 10 J), and this has led to the development of low energy compressional Z-pinch designs. One example of these is the radio-frequency preionized xenon Z-pinch (M. McGeoch, Applied Optics 37, 1651-1658 (1998)). Another is the Star Pinch, that employs an array of intersecting pre-ionizing beams in low density xenon gas to generate a short Z-pinch remote from containment walls (M. McGeoch, Chapter 15, “EUV Sources for Lithography”, Ed. V. Bakshi, SPIE Press, Bellingham Wash. USA (2006)). In all types of Z-pinch, the initial plasma has to have the highest possible uniformity and symmetry, to enable stable and accurate compression to a defined axial location.

Prior methods of creating a symmetrical start plasma include radio-frequency pre-ionization (McGeoch, U.S. Pat. No. 5,504,795 (1996)) and injection of a plasma plume (W. Hartmann et al, Appl. Phys. Lett. 58, 2619-2621, (1991)). The first of these requires a cylindrical insulating dielectric barrier through which the radio frequency energy is transmitted to the low density gas, ionizing it to provide a very uniform hollow plasma cylinder suitable for compression. However, the disposition of the dielectric cylinder precludes wide angle collection of the radiation produced in the compressed (Z-pinch) plasma. In addition, a dielectric barrier is not possible when lithium is used as the working gas because of chemical reactivity. The second of these (Hartmann et al.) introduces the additional complexity of an external plasma generating device, and essentially passes the symmetry requirement along to the plasma initiation in that device. No provision is made for the containment of a gas such as lithium.

Therefore, improved methods to create a highly symmetrical cylindrical plasma are needed, with particular reference to the problem of the creation of a symmetrical plasma when the working gas is lithium.

### SUMMARY OF INVENTION

The Z-pinch plasma generator of the present invention can provide a compressed plasma target for the laser heated discharge plasma (LHDP) extreme ultraviolet (EUV) source (McGeoch US-2009-0212241-A1). Another application of the present invention is to provide a dense cylindrical plasma target for a laser-pumped recombination super-fluorescence EUV source.

Typically the final diameter of the compressed Z-pinch plasma is less than 1 mm, but for effective laser excitation and subsequent transport of the emitted radiation via an optical system the lateral position of the compressed plasma must remain constant in space to within a small fraction of 1 mm. The positional stability of a Z-pinch is primarily determined by the exact cylindrical symmetry of the low density start plasma. We disclose an electrode configuration that provides a very symmetrical hollow cylinder of low density plasma. A further electrode configuration provides for a central cool, dense “core” plasma target surrounded by a hot “liner” plasma which compresses the core.

According to a first aspect of the invention, a configuration comprises two opposed electrodes with conical depressions on an axis of rotational symmetry with a magnetic field parallel to the said axis in which an applied voltage generates an azimuthally uniform ionization in a gas within and between the electrodes and a high current is passed through the gas between the said electrodes to generate an axial plasma Z-pinch.

According to a second aspect of the invention, a configuration comprises two opposed hollow electrodes each with a compound interior profile comprising an outer flared length and an inner parallel-sided length, with a magnetic field parallel to the common axis, in which an applied voltage generates an azimuthally uniform hollow liner of ionized gas connecting the flared surfaces of the electrodes and a high current passed through this liner compresses a central gas core to generate a dense, cool, plasma target.

### BRIEF DESCRIPTION OF DRAWINGS

For a better understanding of the present invention, reference is made to the accompanying drawings, which are incorporated herein by reference and in which:

FIG. 1 is a cross-sectional view of an electrode configuration with cylindrical symmetry, in accordance with an embodiment of the invention;

FIG. 1A is a cross-sectional view of the electrode configuration of FIG. 1, along the axis thereof;

FIG. 2A is a cross-sectional view of an electrode configuration, in accordance with another embodiment of the invention;

FIG. 2B is a cross-sectional view of the electrode configuration of FIG. 2A, along the axis thereof;

FIG. 2C is a cross-sectional view of the electrode configuration of FIG. 2A, showing a final plasma geometry;

FIG. 2D is a cross-sectional view of the electrode configuration of FIG. 2C, along the axis thereof;

FIG. 3 is a graph of a typical current waveform of electrode current as a function of time for the embodiment of FIGS. 2A-2D;

FIG. 4 is a cross-sectional view of the electrode configuration of FIGS. 2A-2B, wherein the dense core is used as the target plasma in an LHDP extreme ultraviolet light source, in accordance with embodiments of the invention;

FIG. 5 is a cross-sectional view of the electrode configuration used for longitudinal pumping of a lithium 13.5 nanometer recombination laser, in accordance with embodiments of the invention;

FIGS. 6A-6C are cross-sectional views of an electrode configuration for a longitudinally pumped recombination laser, in accordance with embodiments of the invention; and

FIG. 7 is a cross-sectional view of a system that incorporates the electrode configuration, in accordance with embodiments of the invention.

### DETAILED DESCRIPTION

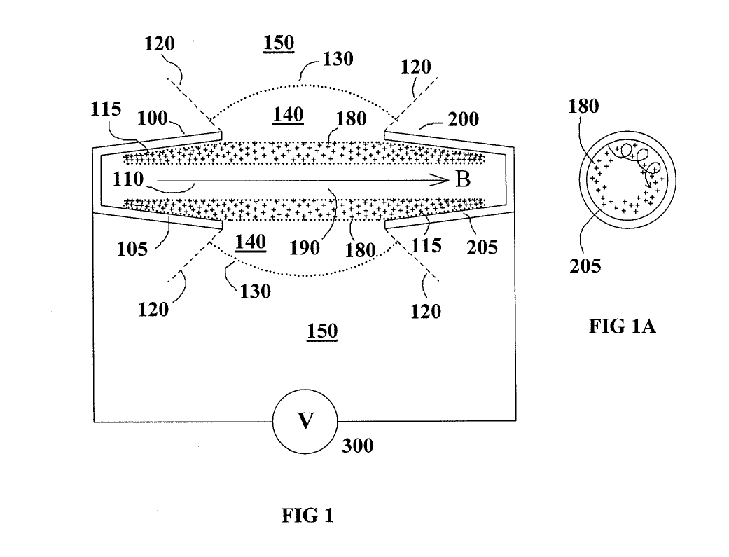

The operation of a first embodiment of the invention is described with reference to FIG. 1, which shows a cross section of a two-electrode configuration with cylindrical symmetry about axis of rotation 110. Electrodes 100 and 200 are identical and opposed to each other. The outer envelope of each electrode, illustrated in cross section by broken lines 120 may be conical in shape. The interior of the electrode configuration within boundary 130 is filled with a low pressure working gas 140. When working gas 140 is a condensible metal vapor such as lithium, a buffer gas region 150 is used to contain and recycle the metal vapor according to the wide angle heat pipe principle (McGeoch, U.S. Pat. No. 7,479,646 (2009)). The heat pipe surfaces necessary for the reflux of liquid metal are not shown in FIG. 1, as they are not part of the present invention. A uniform magnetic field B is present parallel to the axis of symmetry 110 of the electrodes.

Alternating electric pulses are applied via voltage generator 300 between electrodes 100 and 200, at sufficiently high frequency for the plasma electrons and ions from a previous pulse to have only partially recombined by the time the next pulse is applied. A sufficient frequency exceeds 1 kHz. An upper frequency limit of 100 kHz is imposed by the acoustic recovery time of the plasma. As a voltage pulse is applied, the negatively pulsed electrode develops a plasma sheath 115 inside its internal conical surface 105, 205 (relating to electrodes 100 and 200 respectively), depending upon the phase of the alternating applied voltage. Ions drawn from this sheath land on the negatively pulsed electrode surface and produce secondary electrons. These secondary electrons undergo crossed field drift in the perpendicular electric field of the sheath and the applied magnetic field. The drift is azimuthal, within the electrode conical depression, parallel to the electrode surface, as illustrated in FIG. 1A, which depicts for example electron motion inside the internal conical surface 205 of electrode 200. Such electrons ionize the gas they are passing through, and these ions in turn fall to the surface 205 beneath them, producing more secondary electrons. The result of this rapid azimuthal crossed field drift is a very uniformly disposed plasma 180, symmetrical about the axis 110 of the device. In time, as the density grows, electrons find their way to the open entrance of the conical depression, and drift in the voltage-applied longitudinal electric field toward the opposite electrode, creating further secondary electrons and ions in the same cylindrically uniform mode. As the current between the electrodes ramps up, the self-magnetic force compresses or pinches the cylindrical start plasma to a central hot plasma that can be used to generate extreme ultraviolet or soft X-ray photons, either directly or as the result of additional external heating by a focused laser in a device such as the laser heated discharge plasma source [McGeoch, US Pat. Publ. US-2009-0212241-A1]. The uniform characteristics of the type of crossed field discharge generated in the present invention have previously been discussed in the context of a plasma cathode for an electron gun in McGeoch (J. Appl. Phys. 71, 1163-1170 (1992)).

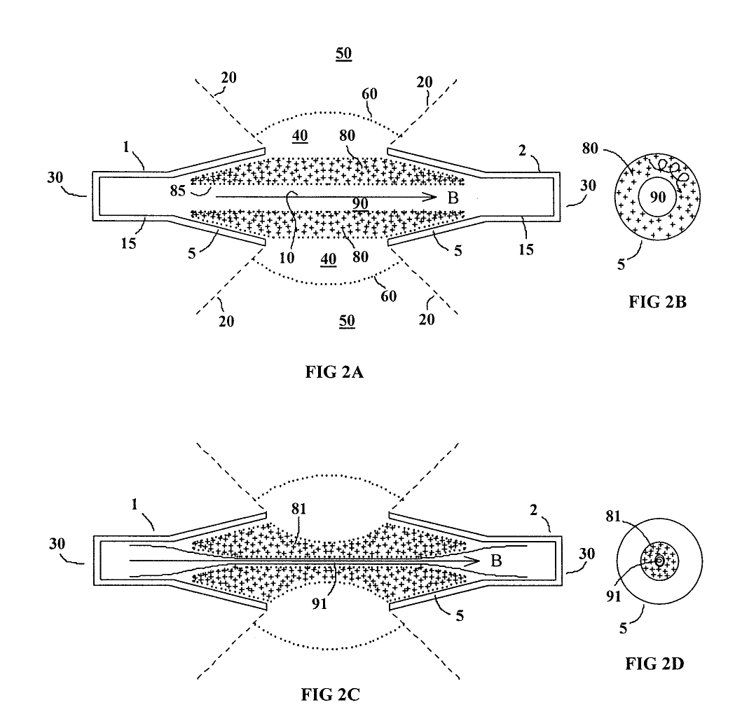

A second embodiment of the invention that is able to generate a dense, cool, cylindrical plasma core is illustrated in FIGS. 2A-2D. Two identical opposed hollow electrodes 1, 2 have rotational symmetry about axis 10. The hollow interior of each electrode is composed of an outer flared portion 5, which may be conical, and an inner straight portion 15 which is cylindrical. The outer envelope of each electrode, illustrated in cross section by broken lines 20 in FIGS. 2A and 2C, may be conical in shape. The hollow electrodes 1, 2 have closures 30 at the outermost extent of cylindrical sections 15. A working gas 40, which may be lithium vapor, fills each hollow electrode and the region between them. If the working gas is a condensible metal such as lithium, there is a helium buffer region 50 surrounding it. The boundary 60 between the lithium working gas and the helium buffer is established by the disposition of a wide-angle heat pipe structure of the type described in U.S. Pat. No. 7,479,646 (McGeoch, 2009). As the heat pipe structure is only necessary in the case of a condensible working gas, it is not shown in FIGS. 2A-2D which relate to the concept in the general case for which the working gas need not be condensible. The opposed hollow electrodes 1, 2 are immersed in a magnetic field B that is aligned with the axis 10 of rotational symmetry of the electrodes.

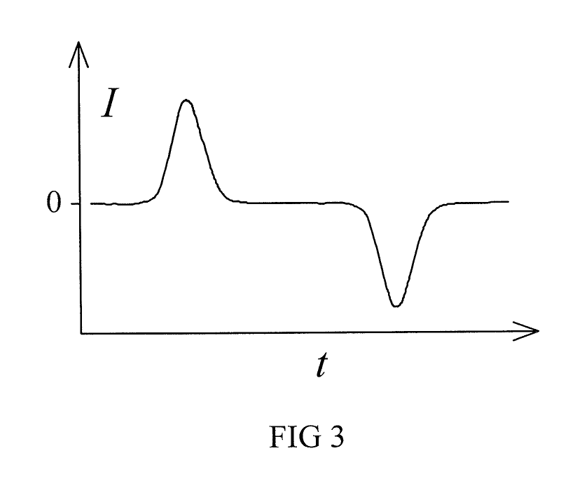

In operation, alternating electric pulses are applied between electrodes 1 and 2, at sufficiently high frequency for the plasma electrons and ions from a previous pulse to have only partially recombined by the time the next pulse is applied. A typical current waveform is shown in FIG. 3. As a voltage pulse is applied, the negatively pulsed electrode develops a plasma sheath inside its internal flared surface 5 which may be conical. Ions drawn from this sheath land on the negatively pulsed electrode surface and produce secondary electrons. These secondary electrons undergo crossed field drift in the perpendicular electric field of the sheath and the applied magnetic field. The drift is azimuthal, within the electrode conical depression 5, parallel to the electrode surface, as illustrated in FIG. 2B, which depicts electron motion inside the conical depression of an electrode. Such electrons ionize the gas they are passing through, and these ions in turn fall to the surface beneath them, producing more secondary electrons. The result of this rapid azimuthal crossed field drift is a very uniformly disposed plasma 80, symmetrical about the axis of the device. In time, as the density grows, electrons find their way to the open entrance of the conical depression, and drift in the voltage-applied longitudinal electric field toward the opposite electrode, creating further secondary electrons and ions in the same cylindrically uniform mode.

A central cylinder 90 defined by the radius of the end closures 30 as shown in FIG. 2A, is not significantly ionized by this process. Because cross-magnetic field diffusion of the discharge plasma is slow on the timescale of a current pulse, the discharge plasma 80 has a sharp magnetically insulated inner boundary 85 separating it from interior core 90 in which current does not flow because the path is longer between end closures 30 relative to the path between surfaces 5 created by the outer discharge plasma 80. Because the core plasma 90 is not heated by the passage of current its temperature remains cool so that its resistivity continues to be high, reinforcing the preference of the inter-electrode current to flow in the outer liner 80. As the current in plasma 80 between the electrodes ramps up, the self-magnetic force compresses or pinches this hollow cylindrical start plasma to a final geometry shown in FIG. 2C in which a hot, compressed current-carrying liner plasma 81 surrounds a very dense and relatively cooler core plasma 91.

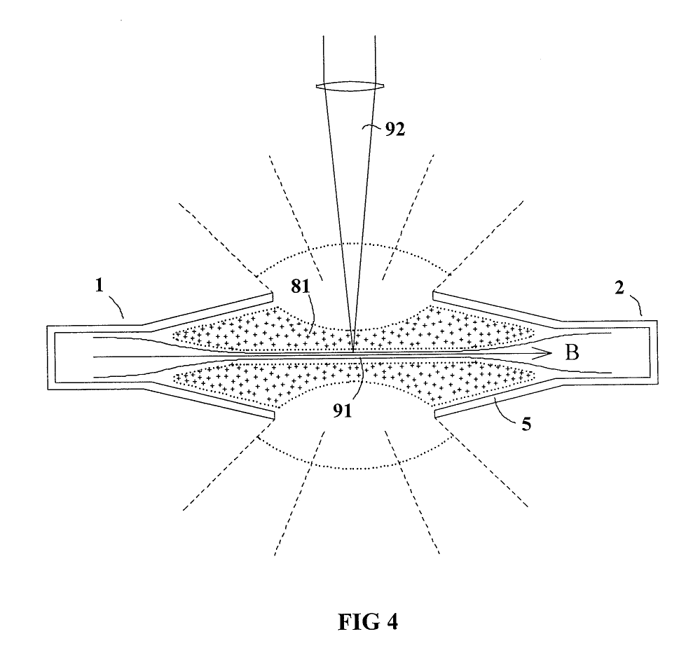

Dense core 91 may be used as the target plasma in the LHDP extreme ultraviolet light source (McGeoch US-2009-0212241-A1), of which one embodiment is illustrated in FIG. 4. As shown in FIG. 4, laser heating by the inverse bremsstrahlung absorption mechanism is strong in core 91 but weak in liner 81, because the absorption coefficient depends strongly on the electron density and increases with decreasing temperature. A radially incident beam 92 therefore deposits most energy in the dense core.

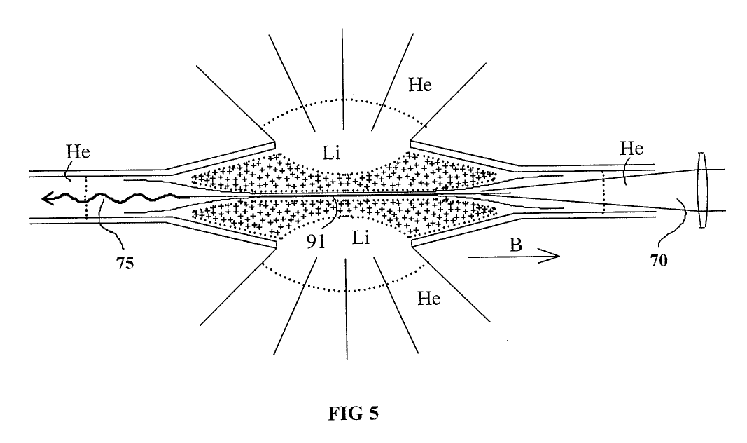

Dense core 91 of FIG. 2C may also be used as the target plasma in a recombination super-fluorescence laser EUV source, illustrated in FIG. 5. The conventional method of target plasma production for such EUV lasers is via laser irradiation of a fiber (Suckewer, U.S. Pat. No. 4,704,718 (1987)) or a solid metal surface (Rocca, U.S. Pat. No. 7,609,816 (2009)). In these approaches, once a dense linear target plasma has been formed via a first laser pulse, a second very short and intense laser pulse excites the working substance to create strong ionization. Short wavelength laser action occurs on recombination of the plasma. Each of these laser-driven plasma generation methods suffers from limited life of the target, whereas the Z-pinch target plasma of the present invention is renewable at high repetition rate for more than 1 billion pulses. A simpler EUV laser system results in that plasma production is via a pinch discharge and only one laser, the intense, very short pulse laser, is required.

One of the recombination laser candidates for which gain has been demonstrated is the lithium recombination laser at 13.5 nm. In this laser an intense optical pulse, in the range of 10¹⁷ Wcm⁻² at wavelength preferably less than 1 micron and duration less than 1 psec is directed along the axis of the plasma dense core. The lithium in the core is essentially completely ionized via optical field ionization. It re-combines into the Li2⁺(2p) upper laser level in a time short compared to the 26 psec spontaneous emission lifetime of that level. A population inversion leads to amplified spontaneous emission along the axis of the plasma, with 13.5 nm light emitted at the ends. Prior studies [Nagata et al, Phys. Rev. Lett. 71, 3774-3777 (1993); Donnelly et al., J. Opt. Soc. Amer. B, 14, 185-188 (1996)] have shown that highest laser gain occurs for plasma densities exceeding 5×10¹⁸ lithium ions cm⁻³, a range that is achievable using the present plasma generating device. The laser gain is greatest for an initially cool plasma, which is a condition that can be achieved in the plasma target of the present invention because current does not flow in the core cylinder, but only in the liner. FIG. 5 illustrates the plasma target of the present invention in use for longitudinal pumping of a lithium 13.5 nm recombination laser. The electrode end closures 30 of FIG. 2 have been replaced by tubes that extend the cylindrical portions 15 of FIG. 2 into a cylindrical access tube for the intense pump beam 70 and egress for the generated EUV beam 75. In the case of lithium as the working gas, these access tubes are heat pipes that operate on the buffer gas heat pipe principal, and there is a transition to a helium buffer gas. With reference to FIG. 5, in operation the generation of a plasma target proceeds as described in relation to FIGS. 2A-2D. When dense core 91 is formed, intense laser beam 70 ionizes a channel along the axis of dense core 91, and beam 75 of amplified spontaneous emission is radiated at the exit end of the ionization channel.

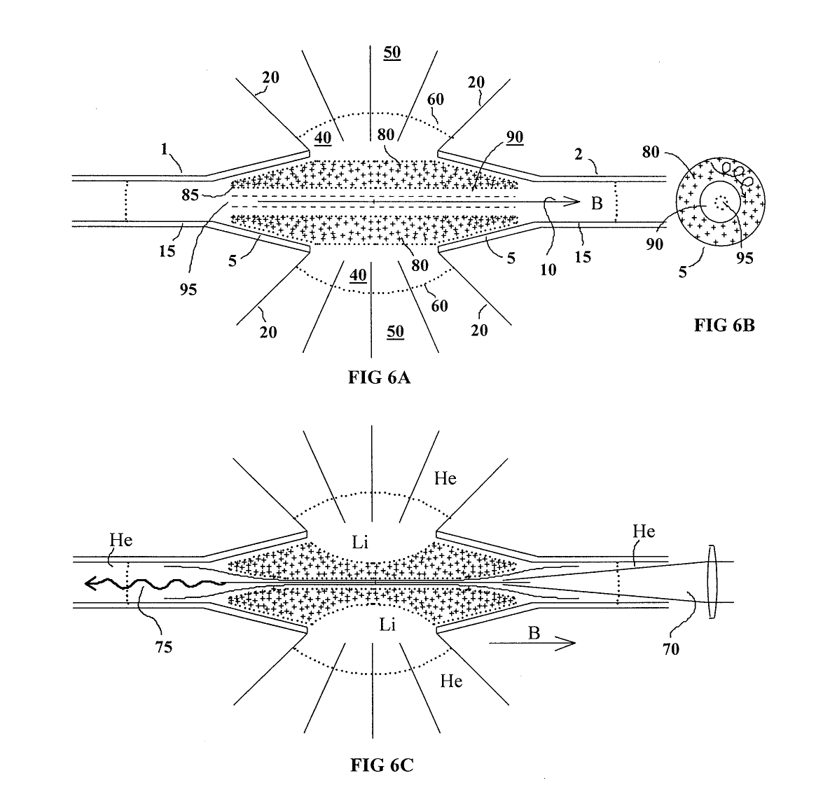

A further improvement relating to use of the above described second embodiment of the invention for a longitudinally pumped recombination laser is illustrated in FIGS. 6A, 6B and 6C. It is known that a principal limitation of lithium recombination lasers at 13.5 nm is de-focusing of both the intense pump laser and the generated 13.5 nm radiation, due to lack of a guiding refractive index structure. In a uniform medium, the production of ionization in a narrow axial cylinder by the intense pump beam creates an axially peaked electron density. The refractive index of free electrons is negative, so a defocusing structure is created and the pump beam diverges after a short distance, limiting the length available for amplification of spontaneous emission.

Our further improvement relates to the provision of a radially increasing electron density profile that guides the pump laser for a much longer distance. In FIGS. 6A and 6B we illustrate a method whereby the ion density may be reduced within a cylinder 95 that is axially located within gas cylinder 90. This is achieved as follows: prior to compression by current carrying liner 80 an axially propagating laser beam partially photo-ionizes gas in an interior cylinder 95. This creates a heated region 95 along the axis of cylinder 90 as shown in cross section in FIG. 6B. Upon compression, the material within heated region 95, being initially at higher temperature, is not compressed to such a high density as the surrounding bulk of gas cylinder 90. The final compressed dense core 91 therefore contains embedded within it a low density axial core that contains the gas initially located in cylinder 95. Optically induced ionization by the intense pump laser beam 70 of FIG. 6C is essentially complete ionization, occurring on a timescale very short compared to the time required for a density adjustment by ion motion. Therefore optically induced ionization creates an electron density profile that follows the designed ion density profile, having a lower density axial region. This can provide the necessary focusing for co-axial guided propagation of the intense pump laser 70 together with the amplified spontaneous emission 75 that is generated following recombination. When the gas medium of this configuration is lithium, the required pre-heating of region 95 can be performed by axial passage of a pulsed 193 nm ArF laser prior to initiation of the pinch current pulse through liner 85. The absorption cross section for 193 nm light by lithium atoms is 1.6×10⁻¹⁸ cm², and the product is a singly ionized Li atom plus a low energy photoelectron. Each such absorption contributes 6.4 eV of internal energy within column 95 that enables it to resist compression by liner 80, thereby generating the desired low density on axis.

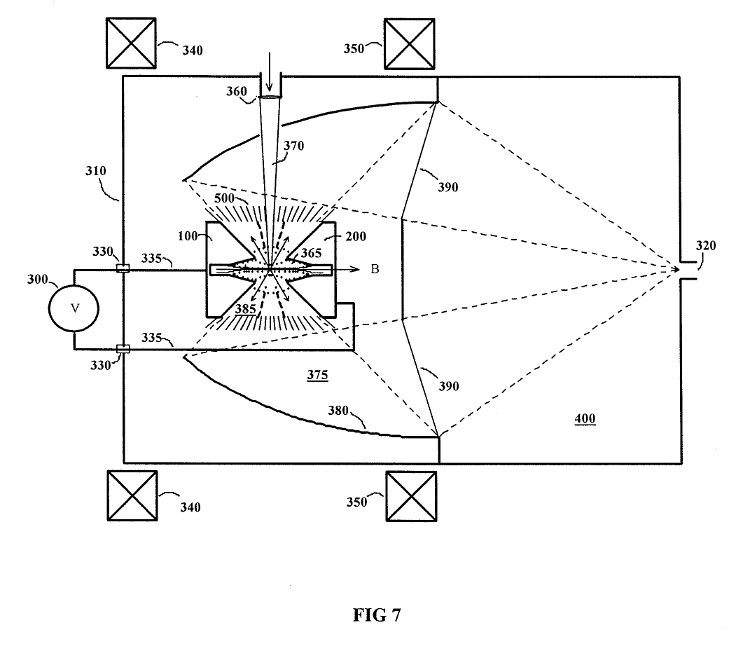

An example of a system that incorporates the present invention is shown in FIG. 7. This exemplary system is designed to generate extreme ultraviolet (EUV) light using the laser heated discharge plasma (LHDP) principle. The present invention is shown here supplying the target plasma at the center of the LHDP approach. With reference to FIG. 7, a cylindrical vacuum tank 310, with a horizontal axis of symmetry, contains an electrode configuration in accordance with embodiments of the present invention comprising electrodes 100 and 200. A voltage generator 300 is connected via leads 335 to each electrode. The leads enter the vacuum tank via insulated leadthrough components 330. A coaxial magnetic field in accordance with embodiments of the invention is supplied via field coils 340 and 350, which may be located outside the wall of vacuum tank 310. An entry lens window 360 admits a laser beam for the purpose of heating a small region within the plasma generated on the axis between the electrodes. In this exemplary system, region 385 contains a helium buffer gas and region 365 contains a working metal vapor gas such as lithium. A “honeycomb” structure 500 serves to reduce the helium pressure between region 385 and region 375, so as to reduce the absorption of extreme ultraviolet (EUV) light as it propagates through region 375 between the point of production and a collection ellipsoidal mirror 380. Following reflection off mirror 380, EUV light passes through a thin membrane 390 and propagates through vacuum region 400 to focal position 320 at which there is an exit vacuum path to the device in which the EUV light is used. The foregoing is only one example of many different systems that may incorporate as a sub-component the present invention as defined in the claims attached hereto, and is not to be construed as limiting the scope of the present invention.

Further realizations of this invention will be apparent to those skilled in the art. Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A configuration comprising two opposed electrodes with conical depressions on an axis of rotational symmetry with a magnetic field parallel to the said axis in which an applied voltage generates an azimuthally uniform ionization in a gas within and between the electrodes and a high current is passed through the gas between the said electrodes to generate an axial plasma Z-pinch.

2. A configuration as in claim 1, in which the operating gas is helium, lithium or a mixture of helium and lithium.

3. A configuration as in claim 1, in which an oscillating positive and negative applied voltage is applied between the electrodes.

4. A configuration as in claim 3, in which the frequency of oscillation of the applied voltage lies in the range 1 kHz to 100 kHz.

5. A configuration as in claim 2, in which lithium is confined within a wide angle heat pipe of which the electrodes comprise an element.

6. A configuration as in claim 1, in which a small region of the Z-pinch is heated by a focused laser to provide locally increased ionic excitation and consequent locally increased emission of extreme ultraviolet light, according to the LHDP extreme ultraviolet source principle.

7. A configuration as in claim 1, in which an extended length of the Z-pinch is heated by a focused laser to provide substantially complete ionization of lithium gas, followed by recombination stimulated emission along the pinch axis at the wavelength of 13.5 nm.

8. A configuration comprising two opposed hollow electrodes each with a compound interior profile comprising an outer flared length and an inner parallel-sided length, with a magnetic field parallel to the common axis, in which an applied voltage generates an azimuthally uniform hollow liner of ionized gas connecting the flared surfaces of the electrodes and a high current passed through this liner compresses a central gas core to generate a dense, cool, plasma target.

9. A configuration as in claim 8, in which the flared surface is conical.

10. A configuration as in claim 8, in which the operating gas is helium, lithium or a mixture of helium and lithium.

11. A configuration as in claim 8, in which an oscillating positive and negative applied voltage is applied between the electrodes.

12. A configuration as in claim 8, in which the working gas is confined within a wide angle heat pipe of which the electrodes comprise an element.

13. A configuration as in claim 8, in which a small region of the Z-pinch is heated by a focused laser to provide locally increased ionic excitation and consequent locally increased emission of extreme ultraviolet light, according to the LHDP extreme ultraviolet source principle.

14. A configuration as in claim 8, in which an extended length of the Z-pinch is heated by a focused laser to provide substantially complete ionization of lithium gas, followed by recombination stimulated emission lasing along the pinch axis at the wavelength of 13.5 nm.

15. A configuration as in claim 14, in which the focused heating laser pulse is directed axially along the common axis.

16. A configuration as in claim 8, in which prior to compression the central gas core has imprinted within it a radial temperature profile with an on-axis temperature maximum, to provide upon compression an on-axis density minimum that focuses both an axially propagating pump laser and the resultant axially propagating recombination stimulated emission.

17. A configuration as in claim 16, in which the working gas is lithium and the radial temperature profile is established via photoionization heating produced by axial propagation of a 193 nm pulsed laser beam.
